(19) United States
(12) Patent Application Publication
(10) Pub. No.: US 2010/0222247 A1
(43) Pub. Date: Sep. 2, 2010

(54) Cleaning Agent

(76) Inventors: Johannes Zipfel, Dusseldorf (DE); Nadine Warkotsch, Dusseldorf (DE); Arnd Kessler, Monheim am Rhein (DE); Christian Nitsch, Dusseldorf (DE); Sven Müller, Duisburg (DE); Luca Bellomi, Dusseldorf (DE)

Correspondence Address: Henkel Corporation, 10 Finderne Avenue, Suite B, Bridgewater, NJ, 08807, US

(21) Appl. No.: 12/720,919

(22) Filed: Mar. 10, 2010

Related U.S. Application Data
(63) Continuation of application No. PCT/EP2008/061469, filed on Sep. 1, 2008.

(30) Foreign Application Priority Data
Sep. 10, 2007 (DE) 10 2007 042 907.1

(51) Int. Cl. C11D 3/00

(52) U.S. Cl. 510/222

(57) ABSTRACT

Liquid, low-alkaline and bleach-free dishwasher detergent having a pH value (20° C.) of 8 to 12 and containing: a) 10 to 60 percent by weight of a builder; b) more than 1.5 percent by weight of a phosphonate; c) 0.1 to 20 percent by weight of an anionic copolymer comprising: i) unsaturated carboxylic acid(s) and ii) sulfonic acid group-containing monomer(s). Detergents according to the invention exhibit a good cleaning power on bleachable dirt, particularly tea stains.

### CROSS REFERENCE TO RELATED APPLICATIONS

The present application is a continuation of International Patent Application No. PCT/EP2008/061469 filed 1 Sep. 2008, which claims priority to German Patent Application No. 10 2007 042 907.1 filed 10 Sep. 2007, both of which are incorporated herein by reference.

The present Patent Application describes cleaning agents, in particular cleaning agents for automatic cleaning of tableware. The present Application is, in particular, directed towards liquid, low-alkalinity, and bleaching agent-free automatic dishwashing agents.

Automatically washed tableware today is often subject to more stringent requirements than manually washed tableware. For example, an item of tableware that appears to have all food residues completely removed will not be regarded as clean if it still exhibits discolorations after automatic dishwashing that derive, for example, from the deposition of plant-based dyes on the tableware surface.

Bleaching agents are used in automatic dishwashing agents to obtain spot-free tableware. In order to activate these bleaching agents and achieve an improved bleaching effect when cleaning at temperatures of 60° C. and below, automatic dishwashing agents generally also contain bleach activators or bleach catalysts, with bleach catalysts particularly proven to be especially effective.

Still, there are limits to the use of these bleaching agents, for example, due to their incompatibility with other ingredients having washing or cleaning activity (e.g., enzymes), or due to stability problems when bleaching agent-containing washing or cleaning agents are stored. This applies in particular to liquid washing or cleaning agents.

One technical possibility for improving the cleaning performance of automatic dishwashing agents, in particular bleaching agent-free automatic dishwashing agents, involves elevating the alkalinity of those agents. However, while cleaning performance of automatic dishwashing agents increases with rising alkalinity, highly alkaline cleaners can also cause damage to the silicate structure of glasses, and can trigger severe irritation upon skin contact. It is therefore desirable to limit the alkalinity of the automatic dishwashing agent.

Accordingly, the present application provides a liquid cleaning agent for tableware cleaning having improved cleaning performance versus conventional tableware cleaning agents, even in low-temperature cleaning cycles or cleaning cycles with low water consumption. The tableware cleaning agent in particular provides improved cleaning performance with respect to bleachable stains, despite being free of bleaching agent, without simultaneously causing increased damage to glass or ceramic surfaces. Included among bleachable stains in this context are, for example, stains resulting from tea or plant-based dyes such as from vegetables or fruit.

It has been found, surprisingly, that the aforesaid object can be achieved by a combination of builders, phosphonates, and sulfonic acid group-containing polymers.

A first aspect of the present application is therefore a liquid, low-alkalinity, and bleaching agent-free automatic dishwashing agent having a pH (20° C.) of from about 8 to about 12, containing—

a) about 10 to about 60 wt % of one or more builders,

b) at least 1.5 wt % of one or more phosphonates, and

c) about 0.1 to about 20 wt % of an anionic copolymer comprising
i) one or more unsaturated carboxylic acids, and
ii) one or more sulfonic acid group-containing monomers.

As mentioned above, while elevated alkalinity of an automatic dishwashing agent contributes to the cleaning performance of that agent, it also increases the corrosive and irritating effect of that agent. Preferred automatic dishwashing agents according to the present invention therefore have a pH (20° C.) of from about 9 to about 11.5, preferably from about 9.5 to about 11.5.

Aqueous automatic dishwashing agents are preferred according to the present invention. Water content of these aqueous automatic dishwashing agents is preferably from about 10 to about 80 wt %, by preference from about 20 to about 70 wt %, and in particular from about 30 to about 60 wt %, based on total weight of the automatic dishwashing agent.

As a first ingredient, automatic dishwashing agents according to the present invention contain one or more builders. These builders include, in particular, carbonates, phosphates, organic cobuilders, and silicates.

It is particularly preferred to use carbonate(s) and/or hydrogencarbonate(s), by preference alkali carbonate(s), particularly preferably sodium carbonate, in an amount of from about 2 to about 30 wt %, by preference from about 3 to about 20 wt %, and in particular from about 4 to about 15 wt %, based on total weight of the automatic dishwashing agent.

Organic cobuilders that may be mentioned include polycarboxylates/polycarboxylic acids, polymeric carboxylates, aspartic acid, polyacetals, dextrins, and organic cobuilders. These substance classes are described below.

Usable organic builder substances include polycarboxylic acids, which can be used in the form of the free acid and/or its sodium salts, “polycarboxylic acids” being understood as those carboxylic acids that carry more than one acid function. These are, for example, citric acid, adipic acid, succinic acid, glutaric acid, malic acid, tartaric acid, maleic acid, fumaric acid, sugar acids, aminocarboxylic acids, and nitrilotriacetic acid (NTA), provided such use is not objectionable for environmental reasons, as well as mixtures thereof. Free acids typically also possess an acidifying component in addition to their builder effect, and thus also serve to establish a lower and milder pH for washing or cleaning agents. Worthy of mention in this context are, in particular, citric acid, succinic acid, glutaric acid, adipic acid, gluconic acid, and any mixtures thereof.

Particularly preferred automatic dishwashing agents according to the present invention contain citrate as one of the builders. Automatic dishwashing agents containing about 2 to about 40 wt %, by preference about 5 to about 30 wt %, and in particular about 7 to about 20 wt % citrate, are preferred according to the present invention. Citrate and citric acid together with the phosphates have proven to be builders that, in combination with phosphonate, in particular 1-hydroxyethane-1,1-diphosphonic acid, and the sulfonic acid group-containing copolymers, are most effective in terms of cleaning performance, such as rinsing performance and particularly deposit inhibition.

Polycarboxylates are also suitable as organic builders. These are, for example, the alkali-metal salts of polyacrylic acid or of polymethacrylic acid (e.g., those having a relative molecular weight from about 500 to about 70,000 g/mol).

Suitable polymers include, in particular, polyacrylates, preferably having a molecular weight from about 2000 to about 20,000 g/mol. Because of their superior solubility, short-chain polyacrylates having molar weights from about 2000 to about 10,000 g/mol, particularly from about 3000 to about 5000 g/mol, may in turn be preferred.

Also suitable are copolymeric polycarboxylates, in particular those of acrylic acid with methacrylic acid and of acrylic acid or methacrylic acid with maleic acid. Copolymers of acrylic acid with maleic acid that contain about 50 to about 90 wt % acrylic acid and about 50 to about 10 wt % maleic acid have proven particularly suitable. Their relative molecular weight, based on free acids, is generally about 2000 to about 70,000 g/mol, by preference about 20,000 to about 50,000 g/mol, and in particular 30,000 to about 40,000 g/mol.

The concentration of (co)polymeric polycarboxylates in the automatic dishwashing agents is by preference about 0.5 to about 20 wt %, and in particular about 3 to about 10 wt %.

Automatic dishwashing agents according to the present invention can contain, as a builder, crystalline sheet-form sodium silicates of the general formula NaMSiₓ0₂ₓ₊₁.yH₂O wherein M is sodium or hydrogen; x is a number from 1.9 to 22, preferably from 1.9 to 4, particularly preferably 2, 3, or 4; and y is a number from 0 to 33, preferably from 0 to 20.

In addition to citrates, phosphates have proven to be the most effective builders in terms of cleaning performance. Among the plurality of commercially obtainable phosphates, alkali-metal phosphates have the greatest significance in the washing- and cleaning-agent industry, with particular preference for pentasodium or pentapotassium triphosphate (sodium or potassium tripolyphosphate).

“Alkali-metal phosphates” refers to alkali-metal (in particular sodium and potassium) salts of various phosphoric acids, in which context a distinction can be made between metaphosphoric acids (HPO₃)ₙ and orthophosphoric acid H₃PO₄, in addition to higher-molecular-weight representatives. Phosphates provide a combination of advantages: they act as alkali carriers, prevent lime deposits on machine parts and lime incrustations in fabrics, and furthermore contribute to cleaning performance.

Phosphates that are technically relevant are pentasodium triphosphate Na₅P₃O₁₀ (sodium tripolyphosphate) and the corresponding potassium salt pentapotassium triphosphate K₅P₃O₁₀ (potassium tripolyphosphate). Sodium potassium tripolyphosphates are also used with preference according to the present invention.

If phosphates are used as substances having washing or cleaning activity in washing or cleaning agents in the context of the present Application, preferred agents then contain phosphate(s), preferably alkali-metal phosphate(s), particularly preferably pentasodium or pentapotassium triphosphate (sodium or potassium tripolyphosphate) in an amount of from about 2 to about 40 wt %, preferably from about 2 to about 30 wt %, and in particular from about 3 to about 25 wt %, particularly preferably from about 3 to about 15 wt %, based on total weight of the washing or cleaning agent.

Also usable are amorphous sodium silicates having a Na₂O: SiO₂ modulus from 1:2 to 1:3.3, preferably from 1:2 to 1:2.8, and in particular from 1:2 to 1:2.6, which by preference are dissolution-delayed and exhibit secondary washing properties.

In preferred automatic dishwashing agents according to the present invention, silicates content, based on total weight of the automatic dishwashing agent, is limited to quantities of about 10 wt % or less, preferably about 5 wt % or less, and in particular about 2 wt % or less. Particularly preferred automatic dishwashing agents according to the present invention are silicate-free.

Automatic dishwashing agents according to the present invention can contain the aforementioned builders both in the form of compositions containing a single builder and in the form of compositions containing mixtures of two, three, four or more builders.

Particularly preferred liquid automatic dishwashing agents contain at least two builders from the group of phosphates, carbonates, and citrates, with the weight proportion of these builders being about 2 to about 50 wt %, preferably about 5 to about 40 wt %, and in particular about 10 to about 30 wt %, based on total weight of the automatic dishwashing agent. The combination of two of more builders from the aforesaid group has proven to be advantageous in the cleaning and rinsing performance of automatic dishwashing agents according to the present invention.

Some examples of formulations for preferred automatic dishwashing agents according to the present invention are illustrated in the tables below:

| | Formulation 1 | Formulation 2 | Formulation 3 | Formulation 4 |
|---|---|---|---|---|
| Ingredient | (wt %) | (wt %) | (wt %) | (wt %) |
| Tripolyphosphate | 2 to 40 | 3 to 15 | — | — |
| Citrate | —** | — | 5 to 30 | 7 to 20 |
| Carbonate | 3 to 20 | 4 to 15 | 3 to 20 | 4 to 15 |
| Phosphonate | >1.5 | >1.5 | >1.5 | >1.5 |
| Anionic copolymer* | 0.1 to 20 | 0.1 to 20 | 0.1 to 20 | 0.1 to 20 |
| Water | 10 to 80 | 20 to 70 | 30 to 70 | 30 to 70 |
| miscellaneous | to 100 | to 100 | to 100 | to 100 |
| | Formulation 5 | Formulation 6 | Formulation 7 | Formulation 8 |
| Ingredient | (wt %) | (wt %) | (wt %) | (wt %) |
| Potassium | 2 to 40 | 3 to 15 | — | — |
| tripolyphosphate | | | | |
| Sodium citrate | — | — | 5 to 30 | 7 to 20 |
| Sodium carbonate | 3 to 20 | 4 to 15 | 3 to 20 | 4 to 15 |
| Phosphonate | >1.5 | >1.5 | >1.5 | >1.5 |
| Anionic copolymer* | 0.1 to 20 | 0.1 to 20 | 0.1 to 20 | 0.1 to 20 |
| Water | 10 to 80 | 20 to 70 | 30 to 70 | 30 to 70 |
| miscellaneous | to 100 | to 100 | to 100 | to 100 |

*Anionic copolymer comprising
i) unsaturated carboxylic acid(s),
ii) sulfonic acid group-containing monomer(s).
**“—” means, in this and in all tables hereinafter, that the formulation contains none of this component.

As a supplement to the aforesaid builders, agents according to the present invention can contain alkali-metal hydroxides. These alkali carriers are used in the cleaning agents preferably only in small quantities, preferably in amounts of about 10 wt % or less, more preferably in amounts of about 6 wt % or less, even more preferably in amounts of about 5 wt % or less, particularly preferably in amounts of from about 0.1 to about 5 wt %, and most particularly in amounts of from about 0.5 to about 5 wt %, based in each case on the total weight of the cleaning agent.

Some examples of formulations for preferred automatic dishwashing agents according to the present invention are illustrated in the table below:

| | Formulation 9 | Formulation 10 | Formulation 11 | Formulation 12 |
|---|---|---|---|---|
| Ingredient | (wt %) | (wt %) | (wt %) | (wt %) |
| Tripolyphosphate | 2 to 40 | 3 to 15 | — | — |
| Citrate | — | — | 5 to 30 | 7 to 20 |
| Carbonate | 3 to 20 | 4 to 15 | 3 to 20 | 4 to 15 |
| Alkali hydroxide | 0.1 to 10 | 0.1 to 6 | 0.1 to 5 | 0.1 to 5 |
| Phosphonate | >1.5 | >1.5 | >1.5 | >1.5 |
| Anionic copolymer* | 0.1 to 20 | 0.1 to 20 | 0.1 to 20 | 0.1 to 20 |
| Water | 10 to 80 | 20 to 70 | 30 to 70 | 30 to 70 |
| miscellaneous | to 100 | to 100 | to 100 | to 100 |

*Anionic copolymer comprising
i) unsaturated carboxylic acid(s),
ii) sulfonic acid group-containing monomer(s).

As a second ingredient, automatic dishwashing agents according to the present invention contain phosphonate(s). The weight proportion of phosphonate, based on total weight of the automatic dishwashing agent, is preferably about 1.8 wt % or more, more preferably about 2.2 wt % or more, and in particular about 2.4 wt % or more phosphonate. Phosphonate content is preferably from about 2 to about 30 wt %, more preferably from about 2 to about 20 wt %, and in particular from about 2 to about 15 wt %.

Complexing phosphonates include a number of different compounds such as 1-hydroxyethane-1,1-diphosphonic acid (HEDP) or diethylenetriaminepenta(methylenephosphonic acid) (DTPMP). Hydroxyalkane- and aminoalkanephosphonates are particularly preferred in this application. Among the hydroxyalkanephosphonates, 1-hydroxyethane-1,1-diphosphonate (HEDP) is of particular use as a cobuilder. It is preferably used as a sodium salt, the disodium salt reacting neutrally and the tetrasodium salt in alkaline fashion (pH 9). Suitable aminoalkanephosphonates are, by preference, ethylenediaminetetramethylenephosphonate (EDTMP), diethylenetriaminepentamethylenephosphonate (DTPMP), and their higher homologs. They are preferably used in the form of neutrally reacting sodium salts (e.g., as a hexasodium salt of EDTMP or as a hepta- and octasodium salt of DTPMP). Of the class of the phosphonates, HEDP is preferably used.

A preferred automatic dishwashing agent according to the present invention comprises one or more of the following phosphonates—

a) aminotrimethylenephosphonic acid (ATMP) and/or salts thereof,

b) ethylenediaminetetra(methylenephosphonic acid) (EDTMP) and/or salts thereof,

c) diethylenetriaminepenta(methylenephosphonic acid) (DTPMP) and/or salts thereof,

d) 1-hydroxyethane-1,1-diphosphonic acid (HEDP) and/or salts thereof,

e) 2-phosphonobutane-1,2,4-tricarboxylic acid (PBTC) and/or salts thereof,

f) hexamethylenediaminetetra(methylenephosphonic acid) (HDTMP) and/or salts thereof,

g) nitrilotri(methylenephosphonic acid) (NTMP) and/or salts thereof.

Automatic dishwashing agents containing 1-hydroxyethane-1,1-diphosphonic acid (HEDP) or diethylenetriaminepenta(methylenephosphonic acid) (DTPMP) as phosphonates are particularly preferred.

Liquid automatic dishwashing agents containing 1-hydroxyethane-1,1-diphosphonic acid (HEDP) as a phosphonate are particularly preferred according to the present invention.

Some examples of formulations for preferred automatic dishwashing agents according to the present invention are illustrated in the tables below:

| | Formulation 13 | Formulation 14 | Formulation 15 | Formulation 16 |
|---|---|---|---|---|
| Ingredient | (wt %) | (wt %) | (wt %) | (wt %) |
| Tripolyphosphate | 2 to 40 | 2 to 30 | 3 to 15 | 3 to 15 |
| Carbonate | 3 to 20 | 3 to 20 | 4 to 15 | 4 to 15 |
| Phosphonate | >1.5 | >2 | >1.5 | >2 |
| Anionic copolymer* | 0.1 to 20 | 0.1 to 20 | 0.1 to 20 | 0.1 to 20 |
| Water | 10 to 80 | 20 to 70 | 30 to 70 | 30 to 70 |
| miscellaneous | to 100 | to 100 | to 100 | to 100 |
| | Formulation 17 | Formulation 18 | Formulation 19 | Formulation 20 |
| Ingredient | (wt %) | (wt %) | (wt %) | (wt %) |
| Potassium | 2 to 40 | 2 to 30 | 3 to 15 | 3 to 15 |
| tripolyphosphate | | | | |
| Sodium carbonate | 3 to 20 | 3 to 20 | 4 to 15 | 4 to 15 |
| Phosphonate | >1.5 | >2 | >1.5 | >2 |
| Anionic copolymer* | 0.1 to 20 | 0.1 to 20 | 0.1 to 20 | 0.1 to 20 |
| Water | 10 to 80 | 20 to 70 | 30 to 70 | 30 to 70 |
| miscellaneous | to 100 | to 100 | to 100 | to 100 |

*Anionic copolymer comprising
i) unsaturated carboxylic acid(s),
ii) sulfonic acid group-containing monomer(s).

As an alternative to phosphonates used according to the present invention, methylglycinediacetic acid (MGDA) can also be used in the automatic dishwashing agents as a complexing agent. Phosphonate is, however, preferred over MGDA because considerably better cleaning results on bleachable stains and improved rinsing results are obtained with phosphonates.

An alternative embodiment of the present invention is therefore a liquid, low-alkalinity, and bleaching agent-free automatic dishwashing agent having a pH (20° C.) from about 8 to about 12 and containing—

a) about 10 to about 60 wt % of one or more builders,

b) about 8 wt % or more MGDA, and

c) about 0.1 to about 20 wt % of an anionic copolymer comprising
i) unsaturated carboxylic acid(s),
ii) sulfonic acid group-containing monomer(s).

Preferred alternative cleaning agents contain MGDA in quantities of about 10 wt % or more, preferably about 15 wt % or more, based on total weight of the automatic dishwashing agent.

Regarding other essential and preferred features of these alternative MGDA-containing automatic dishwashing agents, the indications provided herein regarding phosphonate-containing automatic dishwashing agents according to the present invention are correspondingly applicable.

A third ingredient of phosphonate-containing automatic dishwashing agents according to the present invention is sulfonic acid group-containing copolymers which, in addition to sulfonic acid group-containing monomer(s), include at least one unsaturated carboxylic acid. Sulfonic acid group-containing copolymers can comprise two, three, four, or more different monomer units. Preferred liquid automatic dishwashing agents contain such copolymers in quantities from about 0.2 to about 18 wt %, preferably from about 0.5 to about 15 wt %, and in particular from about 1.0 to about 12 wt %, based on total weight of the automatic dishwashing agent.

Unsaturated carboxylic acids of the formula R¹(R²)C═C(R³)COOH wherein R¹ to R³ are independently —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues as defined above substituted with —NH₂, —OH, or —COOH, or are —COOH or —COOR⁴ where R⁴ is a saturated or unsaturated, straight-chain or branched hydrocarbon residue having 1 to 12 carbon atoms, are particularly preferred.

A liquid, low-alkalinity, and bleaching agent-free automatic dishwashing agent having a pH (20° C.) from about 8 to about 12, containing—

a) about 10 to about 60 wt % of one or more builders,

b) about 1.5 wt % or more phosphonate, and

c) about 0.1 to about 20 wt % of an anionic copolymer comprising
i) carboxyl group-containing monomers of the formula R¹(R²)C═C(R³)COOH wherein R¹ to R³ are independently —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues as defined above substituted with —NH₂, —OH, or —COOH, or are —COOH or —COOR⁴ where R⁴ is a saturated or unsaturated, straight-chain or branched hydrocarbon residue having 1 to 12 carbon atoms, and
ii) sulfonic acid group-containing monomer(s),
   is therefore particularly preferred.

Particularly preferred unsaturated carboxylic acids include acrylic acid, methacrylic acid, ethacrylic acid, <-chloroacrylic acid, <-cyanoacrylic acid, crotonic acid, <-phenylacrylic acid, maleic acid, maleic acid anhydride, fumaric acid, itaconic acid, citraconic acid, methylenemalonic acid, sorbic acid, cinnamic acid, or mixtures thereof. Unsaturated dicarboxylic acids are, of course, also usable.

Among the sulfonic acid group-containing monomers, those of the formula—

R⁵(R⁶)C═C(R⁷)—X—SO₃H

wherein R⁵ to R⁷ are independently —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues substituted with —NH₂, —OH, or —COOH, or are —COOH or —COOR⁴ where R⁴ is a saturated or unsaturated, straight-chain or branched hydrocarbon residue having 1 to 12 carbon atoms, and X is an optional spacer group chosen from —(CH₂)ₙ— where n=0 to 4, —COO—(CH₂)ₖ— where k=1 to 6, —C(O)—NH—C(CH₃)₂—, and —C(O)—NH—CH(CH₂CH₃)—, are preferred.

Among these monomers, those of the formulas—

H₂C═CH—X—SO₃H

H₂C═C(CH₃)—X—SO₃H

HO₃S—X—(R⁶)C═C(R⁷)—X—SO₃H

wherein R⁶ and R⁷ are independently —H, —CH₃, —CH₂CH₃, —CH₂CH₂CH₃—, or —CH(CH₃)₂, and X is an optional spacer group chosen from —(CH₂)ₙ— where n=0 to 4, —COO—(CH₂)ₖ— where k=1 to 6, —C(O)—NH—C(CH₃)₂—, and —C(O)—NH—CH(CH₂CH₃)—, are preferred.

Particularly preferred sulfonic acid group-containing monomers include 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropylacrylate, 3-sulfopropylmethacrylate, sulfomethacrylamide, sulfomethylmethacrylamide, and mixtures of the aforesaid acids or water-soluble salts thereof.

Sulfonic acid groups can exist in the polymers in either partly or entirely neutralized form, (i.e., the acid hydrogen atom of the sulfonic acid group can, in some or all sulfonic acid groups, be exchanged for metal ions, by preference alkali-metal ions, and in particular for sodium ions). Use of partly or entirely neutralized sulfonic acid group-containing copolymers is preferred according to the present invention.

For copolymers containing only monomers from groups i) and ii), monomer distribution of the copolymers preferably used is about 5 to about 95 wt % i) and ii), respectively, preferably about 50 to about 90 wt % monomer from group ii) and about 10 to about 50 wt % monomer from group i), each based on the polymer.

Molar weight of the sulfo-copolymers according to the present invention can be varied in order to adapt the properties of the polymers to the desired application. Preferred automatic dishwashing agents include copolymers having molar weights from about 2000 to about 200,000 gmol⁻¹, by preference from about 4000 to 25,000 about gmol⁻¹, and in particular from about 5000 to about 15,000 gmol⁻¹.

A liquid, low-alkalinity, and bleaching agent-free automatic dishwashing agent having a pH (20° C.) from about 8 to about 12 comprising—

a) about 10 to about 60 wt % of one or more builders,

b) about 1.5 wt % or more phosphonate,

c) about 0.1 to about 20 wt % of an anionic copolymer comprising
i) carboxyl group-containing monomers of the formula R¹(R²)C═C(R³)COOH wherein R¹ to R³ are independently —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues as defined above substituted with —NH₂, —OH, or —COOH, or are —COOH or —COOR⁴ where R⁴ is a saturated or unsaturated, straight-chain or branched hydrocarbon residue having 1 to 12 carbon atoms,
ii) sulfonic acid group-containing monomer(s) of the formula R⁵(R⁶)C═C(R⁷)—X—SO₃H wherein R⁵ to R⁷ are independently —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues substituted with —NH₂, —OH, or —COOH, or are —COOH or —COOR⁴ where R⁴ is a saturated or unsaturated, straight-chain or branched hydrocarbon residue having 1 to 12 carbon atoms, and X is an optional spacer group chosen from —(CH₂)ₙ— where n=0 to 4, —COO—(CH₂)ₖ— where k=1 to 6, —C(O)—NH—C(CH₃)₂—, and —C(O)—NH—CH(CH₂CH₃)—,
   is therefore also particularly preferred according to the present invention.

Some examples of formulations for preferred automatic dishwashing agents according to the present invention are illustrated in the tables below:

| | Formulation 21 | Formulation 22 | Formulation 23 | Formulation 24 |
|---|---|---|---|---|
| Ingredient | (wt %) | (wt %) | (wt %) | (wt %) |
| Tripolyphosphate | 2 to 40 | 2 to 30 | 2 to 30 | 3 to 15 |
| Carbonate | 3 to 20 | 3 to 20 | 3 to 20 | 4 to 15 |
| Phosphonate | >1.5 | >1.5 | >1.5 | >1.5 |
| Anionic copolymer* | 0.1 to 20 | 0.2 to 18 | 0.5 to 15 | 1 to 12 |
| Water | 10 to 80 | 20 to 70 | 30 to 70 | 30 to 70 |
| miscellaneous | to 100 | to 100 | to 100 | to 100 |
| | Formulation 21 | Formulation 22 | Formulation 23 | Formulation 24 |
| Ingredient | (wt %) | (wt %) | (wt %) | (wt %) |
| Tripolyphosphate | 2 to 40 | 2 to 30 | 2 to 30 | 3 to 15 |
| Carbonate | 3 to 20 | 3 to 20 | 3 to 20 | 4 to 15 |
| Phosphonate | >1.5 | >1.5 | >1.5 | >1.5 |
| Anionic copolymer* | 0.1 to 20 | 0.2 to 18 | 0.5 to 15 | 1 to 12 |
| Water | 10 to 80 | 20 to 70 | 30 to 70 | 30 to 70 |
| miscellaneous | to 100 | to 100 | to 100 | to 100 |

*Anionic copolymer comprising
i) carboxyl group-containing monomers of the formula R¹(R²)C═C(R³)COOH wherein R¹ to R³ are independently —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues as defined above substituted with —NH₂, —OH, or —COOH, or are —COOH or —COOR⁴ where R⁴ is a saturated or unsaturated, straight-chain or branched hydrocarbon residue having 1 to 12 carbon atoms,
ii) sulfonic acid group-containing monomer(s) of the formula R⁵(R⁶)C═C(R⁷)—X—SO₃H in which R⁵ to R⁷ are independently —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues substituted with —NH₂, —OH, or —COOH, or are —COOH or —COOR⁴ where R⁴ is a saturated or unsaturated, straight-chain or branched hydrocarbon residue having 1 to 12 carbon atoms, and X is an optional spacer group chosen from —(CH₂)ₙ—where n = 0 to 4, —COO—(CH₂)ₖ—where k = 1 to 6, —C(O)—NH—C(CH₃)₂—, and —C(O)—NH—CH(CH₂CH₃)—.

In a further preferred embodiment, copolymers c) also encompass, alongside carboxyl group-containing monomers and sulfonic acid group-containing monomers, at least one nonionic, preferably hydrophobic, monomer. Use of these hydrophobically modified polymers has made it possible to improve, in particular, the rinsing performance of automatic dishwashing agents according to the present invention.

Liquid automatic dishwashing agents, wherein the automatic dishwashing agent contains as an anionic polymer c) a copolymer comprising—

a) unsaturated carboxylic acid(s),

b) sulfonic acid group-containing monomer(s),

c) further nonionogenic monomer(s),

are preferred according to the present invention.

Nonionic monomers used are preferably monomers of the general formula R¹(R²)C═C(R³)—X—R⁴ wherein R¹ to R³ are independently —H, —CH₃, or —C₂H₅, X is an optional spacer group chosen from —CH₂—, —C(O)O—, and —C(O)—NH—, and R⁴ is a straight-chain or branched saturated alkyl residue having 2 to 22 carbon atoms or an unsaturated, preferably aromatic residue having 6 to 22 carbon atoms.

A further embodiment of the present invention is therefore a liquid, low-alkalinity, and bleaching agent-free automatic dishwashing agent having a pH (20° C.) from about 8 to about 12 containing—

a) about 10 to about 60 wt % of one or more builders,

b) about 1.5 wt % or more phosphonate,

c) about 0.1 to about 20 wt % of an anionic copolymer comprising
i) unsaturated carboxylic acid(s),
ii) sulfonic acid group-containing monomer(s),
iii) monomers of the general formula R¹(R²)C═C(R³)—X—R⁴ wherein R¹ to R³ are independently —H, —CH₃, or —C₂H₅, X is an optional spacer group chosen from —CH₂—, —C(O)O—, and —C(O)—NH—, and R⁴ is a straight-chain or branched saturated alkyl residue having 2 to 22 carbon atoms or an unsaturated, preferably aromatic residue having 6 to 22 carbon atoms.

Particularly preferred nonionic monomers include butene, isobutene, pentene, 3-methylbutene, 2-methylbutene, cyclopentene, hexene, hexene-1,2-methlypentene-1,3-methlypentene-1, cyclohexene, methylcyclopentene, cycloheptene, methylcyclohexene, 2,4,4-trimethylpentene-1,2,4,4-trimethylpentene-2,2,3-dimethylhexene-1,2,4-dimethylhexene-1,2,5-dimethlyhexene-1,3,5-dimethylhexene-1,4,4-dimethylhexane-1, ethylcyclohexyne, 1-octene, <-olefins having 10 or more carbon atoms such as, for example, 1-decene, 1-dodecene, 1-hexadecene, 1-octadecene, and C22-<-olefin, 2-styrene, <-methylstyrene, 3-methylstyrene, 4-propylstryene, 4-cyclohexylstyrene, 4-dodecylstyrene, 2-ethyl-4-benzylstyrene, 1-vinylnaphthalene, 2-vinylnaphthalene, acrylic acid methyl ester, acrylic acid ethyl ester, acrylic acid propyl ester, acrylic acid butyl ester, acrylic acid pentyl ester, acrylic acid hexyl ester, methacrylic acid methyl ester, N-(methyl)acrylamide, acrylic acid 2-ethylhexyl ester, methacrylic acid 2-ethylhexyl ester, N-(2-ethylhexyl)acrylamide, acrylic acid octyl ester, methacrylic acid octyl ester, N-(octyl)acrylamide, acrylic acid lauryl ester, methacrylic acid lauryl ester, N-(lauryl)acrylamide, acrylic acid stearyl ester, methacrylic acid stearyl ester, N-(stearyl)acrylamide, acrylic acid behenyl ester, methacrylic acid behenyl ester, and N-(behenyl)acrylamide, or mixtures thereof.

A weight ratio of constituents c) and b) of less than 3:1 has proven advantageous with regard to both rinsing performance and cleaning performance on bleachable stains. The weight ratio of constituents c) and b) refers in this context to the ratio to one another, in terms of the total weight of the automatic dishwashing agent, of constituents c) and b). With a weight ratio of constituents c) to b) of less than 3:1, the weight proportion of surfactant b) should therefore equal at least one-third of the weight proportion of anionic polymer c). For a weight proportion of the anionic polymer equal to 9 wt % of the total weight of the automatic dishwashing agent, the weight proportion of the surfactant is therefore at least 3 wt % of the total weight of the automatic dishwashing agent.

Liquid automatic dishwashing agents according to one of the preceding claims, wherein the weight ratio of constituents c) and b) is less than 3:1, preferably less than 2.5:1, particularly preferably less than 2:1, and in particular from 2:1 to 1:5, are preferred according to the present invention.

As an additional component, preferred dishwashing agents according to the present invention can contain surfactants. The addition of surfactants has proven advantageous especially with regard to cleaning performance and drying; of the group of the nonionic surfactants, anionic surfactants, and amphoteric surfactants utilized with particular preference, the nonionic surfactants yielded the best results. Anionic and amphoteric surfactants are used by preference in combination with defoamers and foam inhibitors, respectively.

All nonionic surfactants known to one skilled in the art can be used as nonionic surfactants. Suitable nonionic surfactants include alkyl glycosides of the general formula RO(G)ₓ wherein R is a primary straight-chain or methyl-branched, especially methyl-branched in the 2-position, aliphatic residue having 8 to 22, preferably 12 to 18 carbon atoms, and G is a glycose unit having 5 or 6 carbon atoms, by preference glucose. The degree of oligomerization x, which indicates the distribution of monoglycosides and oligoglycosides, is any number from 1 to 10; preferably x is 1.2 to 1.4.

Nonionic surfactants of the amine oxide type, for example, N-cocalkyl-N,N-dimethylamine oxide and N-tallowalkyl-N,N-dihydroxyethylamine oxide, and the fatty acid alkanolamides, can also be suitable. The quantity of these nonionic surfactants is by preference no more than that of the ethoxylated fatty alcohols, in particular no more than half thereof.

A further class of useful nonionic surfactants used either as the only nonionic surfactant or in combination with other nonionic surfactants, is alkoxylated, preferably ethoxylated or ethoxylated and propoxylated, fatty acid alkyl esters, preferably having 1 to 4 carbon atoms in the alkyl chain.

Low-foaming nonionic surfactants can be used as preferred surfactants. With particular preference, washing or cleaning agents, particularly cleaning agents for automatic dishwashing, contain nonionic surfactants from the group of the alkoxylated alcohols. Nonionic surfactants used are preferably alkoxylated, advantageously ethoxylated, particularly primary alcohols having preferably 8 to 18 carbon atoms and an average of 1 to 12 mol ethylene oxide (EO) per mol of alcohol, wherein the alcohol residue can be linear or preferably methyl-branched in the 2-position, or can contain mixed linear and methyl-branched residues, such as those that are usually present in oxo alcohol residues. Particularly preferred, however, are alcohol ethoxylates having linear residues made up of alcohols of natural origin having 12 to 18 carbon atoms (e.g., from coconut, palm, tallow, or oleyl alcohol) and an average of 2 to 8 EO per mol of alcohol. Included among the preferred ethoxylated alcohols are, for example, C₁₂₋₁₄ alcohols with 3 EO or 4 EO, C₉₋₁₁ alcohol with 7 EO, C₁₃₋₁₅ alcohols with 3 EO, 5 EO, 7 EO, or 8 BO, C₁₂₋₁₈ alcohols with 3 EO, 5 EO, or 7 EO, and mixtures thereof, such as mixtures of C₁₂₋₁₄ alcohol with 3 EO and C₁₂₋₁₈ alcohol with 5 EO. The degrees of ethoxylation indicated represent statistical averages, which can be a whole number or a fractional number for a specific product. Preferred alcohol ethoxylates exhibit a restricted distribution of homologs (narrow range ethoxylates, NRE). In addition to these nonionic surfactants, fatty alcohols with more than 12 EO can also be used. Examples of these are tallow fatty alcohols with 14 EO, 25 EO, 30 EO, or 40 EO.

It is therefore particularly preferred to use ethoxylated nonionic surfactants that were obtained from C₆₋₂₀ monohydroxyalkanols or C₆₋₂₀ alkylphenols or C₁₆₋₂₀ fatty alcohols and more than 12 mol, by preference more than 15 mol, and in particular more than 20 mol ethylene oxide per mol of alcohol. A particularly preferred nonionic surfactant is obtained from a straight-chain fatty alcohol having 16 to 20 carbon atoms (C₁₆₋₂₀ alcohol), by preference a C₁₈ alcohol, and at least 12 mol, by preference at least 15 mol, and in particular at least 20 mol ethylene oxide. Among these, the so-called “narrow range ethoxylates” are particularly preferred.

Combinations of one or more tallow fatty alcohols with 20 to 30 EO and silicone defoamers are furthermore used with particular preference.

Nonionic surfactants that have a melting point above room temperature are particularly preferred. Nonionic surfactant(s) having a melting point of about 20° C. or greater, by preference of about 25° C. or greater, particularly preferably from about 25 to about 60° C., and in particular from about 26.6 to about 43.3° C., is/are particularly preferred.

Suitable nonionic surfactants that have melting or softening points in the aforesaid temperature range are, for example, low-foaming nonionic surfactants that can be solid or highly viscous at room temperature. If nonionic surfactants that are highly viscous at room temperature are used, it is then preferred that they have a viscosity of about 20 Pa·s or greater, by preference about 35 Pa·s or greater, and in particular about 40 Pa·s or greater. Nonionic surfactants having a waxy consistency at room temperature are also preferred, depending on their intended application.

Nonionic surfactants from the group of alkoxylated alcohols, particularly preferably from the group of mixed alkoxylated alcohols, and in particular from the group of EO-AO-EO nonionic surfactants, are likewise used with particular preference.

The nonionic surfactant that is solid at room temperature preferably possesses propylene oxide units in the molecule. Such PO units constitute preferably about 25 wt % or less, particularly preferably about 20 wt % or less, and in particular about 15 wt % or less of the total molar weight of the nonionic surfactant. Particularly preferred nonionic surfactants are ethoxylated monohydroxyalkanols or alkylphenols that additionally comprise polyoxyethylene-polyoxypropylene block copolymer units. The alcohol or alkylphenol portion of such nonionic surfactant molecules constitutes about 30 wt % or more, preferably about 50 wt % or more, and in particular about 70 wt % or more of the total molar weight of such nonionic surfactants. Preferred agents are characterized in that they contain ethoxylated and propoxylated nonionic surfactants in which the propylene oxide units in the molecule account for about 25 wt % or less, preferably about 20 wt % or less, and in particular about 15 wt % or less of the total molar weight of the nonionic surfactant.

Nonionic surfactants that are preferred for use derive from the groups of the alkoxylated nonionic surfactants, in particular the ethoxylated primary alcohols, and mixtures of these surfactants with surfactants of greater structural complexity, such as polyoxypropylene/polyoxyethylene/polyoxypropylene (PO/EO/PO) surfactants. (PO/EO/PO) nonionic surfactants of this kind are moreover notable for good foam control.

Further nonionic surfactants having melting points above room temperature that are particularly preferred for use comprise 40 to 70% of a polyoxypropylene/polyoxyethylene/polyoxypropylene block polymer blend comprising 75 wt % of a reverse block copolymer of polyoxyethylene and polyoxypropylene with 17 mol ethylene oxide and 44 mol propylene oxide, and 25 wt % of a block copolymer of polyoxyethylene and polyoxypropylene, initiated with trimethylolpropane and containing 24 mol ethylene oxide and 99 mol propylene oxide per mol of trimethylolpropane.

Low-foaming nonionic surfactants that comprise alternating ethylene oxide and alkylene oxide units have proven to be particularly preferred nonionic surfactants in the context of the present invention. Among these in turn, surfactants having EO-AO-EO-AO blocks are preferred, one to ten EO groups or AO groups being bound to one another in each case before being followed by a block of the respectively other groups. Preferred here are nonionic surfactants of the general formula—

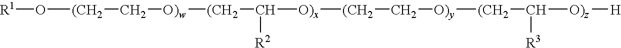

wherein R¹ is a straight-chain or branched, saturated or mono- or polyunsaturated C₆₋₂₄ alkyl or alkenyl residue; R² and R³ are mutually independently —CH₃, —CH₂CH₃, —CH₂CH₂—CH₃, or CH(CH₃)₂; and the indices w, x, y, and z are mutually independently integers from 1 to 6.

Preferred nonionic surfactants of the above formula can be produced using known methods from the corresponding R¹—OH alcohols and ethylene oxide or alkylene oxide. The R¹ residue in the formula above can vary depending on the provenance of the alcohol. When natural sources are used, the R¹ residue has an even number of carbon atoms and is generally unbranched; the linear residues from natural-origin alcohols having 12 to 18 carbon atoms (e.g., from coconut, palm, tallow, or oleyl alcohol) are preferred. Alcohols accessible from synthetic sources include Guerbet alcohols or residues methyl-branched in the 2-position, or mixed linear and methyl-branched residues, such as those usually present in oxo alcohol residues. Regardless of the type of alcohol used to produce the nonionic surfactants contained in the agents, nonionic surfactants wherein R¹ in the above formula is an alkyl residue having 6 to 24, preferably 8 to 20, particularly preferably 9 to 15, and in particular 9 to 11 carbon atoms, are preferred.

In addition to propylene oxide, butylene oxide in particular is possible as the alkylene oxide unit that is alternatingly contained with the ethylene oxide unit in the nonionic surfactants. Also suitable, however, are further alkylene oxides wherein R² and R³ are mutually independently —CH₂CH₂—CH₃ or CH(CH₃)₂. It is preferred to use nonionic surfactants of the above formula wherein R² and R³ are a —CH₃ residue; w and x are mutually independently values of 3 or 4; and y and z are mutually independently values of 1 or 2.

In summary, nonionic surfactants that comprise a C₉₋₁₅ alkyl residue with 1 to 4 ethylene oxide units, followed by 1 to 4 propylene oxide units, followed by 1 to 4 ethylene oxide units, followed by 1 to 4 propylene oxide units, are particularly preferred. These surfactants exhibit the necessary low viscosity in aqueous solution, and are usable according to the present invention with particular preference.

Surfactants of the general formula R¹—CH(OH)CH₂O-(AO)_{w}-(A′O)ₓ-(A″O)_{y}-(A″O)_{z}—R² wherein R¹ and R² are independently a straight-chain or branched, saturated or mono- or polyunsaturated C₂₋₄₀ alkyl or alkenyl residue, A, A′, A″ and A′″ are mutually independently a residue from the group —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃); and w, x, y and z are values between 0.5 and 90, wherein x, y, and/or z can also be 0, are preferred according to the present invention.

Particularly preferred are those end-capped poly(oxyalkylated) nonionic surfactants that, in accordance with the formula R¹O[CH₂CH₂O]_{y}CH₂CH(OH)R², in addition to a residue R¹ that denotes linear or branched, saturated or unsaturated, aliphatic or aromatic hydrocarbon residues having 2 to 30 carbon atoms, by preference having 4 to 22 carbon atoms, further comprise a linear or branched, saturated or unsaturated, aliphatic or aromatic hydrocarbon residue R² having 1 to 30 carbon atoms, where x is a value from 1 to 90, preferably a value from 30 to 80, and in particular value from 30 to 60.

Surfactants of the formula R¹O[CH₂CH(CH₃)O]ₓ[CH₂CH₂O]_{y}CH₂CH(OH)R² wherein R¹ is a linear or branched aliphatic hydrocarbon residue having 4 to 18 carbon atoms or mixtures thereof, R² is a linear or branched hydrocarbon residue having 2 to 26 carbon atoms or mixtures thereof, and x is a value from 0.5 to 1.5, and y is a value of at least 15, are particularly preferred.

Also particularly preferred are those end-capped poly(oxyalkylated) nonionic surfactants of the formula R¹O[CH₂CH₂O]ₓ[CH₂CH(R³)O]_{y}CH₂CH(OH)R² wherein R¹ and R² are independently a linear or branched, saturated or mono- or polyunsaturated hydrocarbon residue having 2 to 26 carbon atoms, R³ is independently —CH₃, —CH₂CH₃, —CH₂CH₂—CH₃, —CH(CH₃)₂, preferably —CH₃, and x and y are independently values from 1 to 32, wherein nonionic surfactants in which R³=—CH₃, and having values from 15 to 32 for x and from 0.5 to 1.5 for y, are very particularly preferred.

By utilizing nonionic surfactants described above having a free hydroxyl group on one of the two terminal alkyl residues, the formation of deposits in automatic dishwashing can be considerably improved compared to conventional polyalkoxylated fatty alcohols without a free hydroxyl group.

Further nonionic surfactants preferably used are end-capped poly(oxyalkylated) nonionic surfactants of the formula R¹O[CH₂CH(R³)O]ₓ[CH₂]ₖCH(OH)[CH₂]ⱼOR² wherein R¹ and R² are linear or branched, saturated or unsaturated, aliphatic or aromatic hydrocarbon residues having 1 to 30 carbon atoms; R³ is H or a methyl, ethyl, n-propyl, isopropyl, n-butyl, 2-butyl, or 2-methyl-2-butyl residue; x is a values from 1 to 30; and k and j are values from 1 to 12, preferably from 1 to 5. If x≧2, each R³ in the above formula R¹O[CH₂CH(R³)O]ₓ[CH₂]ₖCH(OH)[CH₂]ⱼOR² can be different. R¹ and R² are preferably linear or branched, saturated or unsaturated, aliphatic or aromatic hydrocarbon residues having 6 to 22 carbon atoms, wherein residues having 8 to 18 carbon atoms are particularly preferred. For the R³ residue, H, —CH₃, or —CH₂CH₃ are particularly preferred. Particularly preferred values for x are from 1 to 20, in particular from 6 to 15.

As described above, each R³ in the formula above can be different if x≧2. The alkylene oxide unit within square brackets can thereby be varied. If, for example, x is 3, the R³ residue can be selected so as to form ethylene oxide units (R³═H) or propylene oxide units (R³═CH₃), which can be joined to one another in any sequence, for example, (EO)(PO)(EO), (EO)(EO)(PO), (EO)(EO)(EO), (PO)(EO)(PO), (PO)(PO)(EO), and (PO)(PO)(PO). The value of 3 for x was selected here as an example and can certainly be larger; the range of variation increases with rising values of x and includes, for example, a large number of (EO) groups combined with a small number of (PO) groups, or vice versa.

Particularly preferred end-capped poly(oxyalkylated) alcohols of the above formula have values of k=1 and j=1 so that the formula above is simplified to R¹O[CH₂CH(R³)O]ₓCH₂CH(OH)CH₂OR². In the latter formula, R¹, R², and R³ are as defined above, and x is a number from 1 to 30, preferably from 1 to 20, and in particular from 6 to 18. Surfactants in which the R¹ and R² residues have 9 to 14 carbon atoms, R³ denotes H, and x assumes values from 6 to 15, are particularly preferred.

Carbon chain lengths and degrees of ethoxylation or alkoxylation indicated for the aforesaid nonionic surfactants represent statistical averages that can be a whole number or a fractional number for a specific product. As a result of production processes, commercial products of the aforesaid formulas are usually made up not of one individual representative but rather of mixtures, so that average values and, as a consequence, fractional numbers, can result both for the carbon chain lengths and for the degrees of ethoxylation and alkoxylation.

The aforesaid nonionic surfactants can be used not only as individual substances, but also as surfactant mixtures of two, three, four, or more surfactants. “Surfactant mixtures” refers here not to mixtures of nonionic surfactants that fall, in their totality, under one of the aforesaid general formulas, but instead to those mixtures containing two, three, four, or more nonionic surfactants that can be described by different ones of the aforesaid, or other, general formulas.

In a preferred embodiment the automatic dishwashing agent contains, based on total weight, nonionic surfactant(s) in quantities from about 0.1 to about 15 wt %, preferably about 0.2 to about 10 wt %, particularly preferably about 0.5 to about 8 wt %, and in particular from about 1.0 to about 6 wt %.

Some examples of formulations for preferred automatic dishwashing agents according to the present invention are illustrated in the tables below:

| | Formulation 29 | Formulation 30 | Formulation 31 | Formulation 32 |
|---|---|---|---|---|
| Ingredient | (wt %) | (wt %) | (wt %) | (wt %) |
| Tripolyphosphate | 3 to 40 | 3 to 30 | 3 to 30 | 2 to 15 |
| Carbonate | 3 to 20 | 3 to 20 | 3 to 20 | 4 to 15 |
| Phosphonate | >1.5 | >1.5 | >1.5 | >1.5 |
| Anionic copolymer* | 0.1 to 20 | 0.2 to 18 | 0.5 to 15 | 1 to 12 |
| Nonionic surfactant | 0.1 to 15 | 0.2 to 10 | 0.5 to 8 | 1 to 6 |
| Water | 10 to 80 | 20 to 70 | 30 to 70 | 30 to 70 |
| miscellaneous | to 100 | to 100 | to 100 | to 100 |
| | Formulation 33 | Formulation 34 | Formulation 35 | Formulation 36 |
| Ingredient | (wt %) | (wt %) | (wt %) | (wt %) |
| Potassium | 3 to 40 | 3 to 30 | 3 to 30 | 2 to 15 |
| tripolyphosphate | | | | |
| Sodium carbonate | 3 to 20 | 3 to 20 | 3 to 20 | 4 to 15 |
| Phosphonate | >1.5 | >1.5 | >1.5 | >1.5 |
| Anionic copolymer* | 0.1 to 20 | 0.2 to 18 | 0.5 to 15 | 1 to 12 |
| Nonionic surfactant | 0.1 to 15 | 0.2 to 10 | 0.5 to 8 | 1 to 6 |
| Water | 10 to 80 | 20 to 70 | 30 to 70 | 30 to 70 |
| miscellaneous | to 100 | to 100 | to 100 | to 100 |

*Anionic copolymer comprising
i) unsaturated carboxylic acid(s),
ii) sulfonic acid group-containing monomer(s).

Alternatively or in addition to the nonionic surfactants, anionic or amphoteric surfactants can also be used in the automatic tableware cleaning process according to the present invention, preferably in combination with defoamers or foam inhibitors, respectively.

Useful anionic surfactants include those of the sulfonate and sulfate types. Possible sulfonate type surfactants are C₉₋₁₃ alkylbenzenesulfonates, olefinsulfonates (i.e., mixtures of alkene- and hydroxyalkanesulfonates, and disulfonates), for example, those obtained from C₁₂₋₁₈ monoolefins having an end-located or internal double bond, by sulfonation with gaseous sulfur trioxide and subsequent alkaline or acid hydrolysis of the sulfonation products. Also suitable are alkanesulfonates that are obtained from C₁₂₋₁₈ alkanes, for example, by sulfochlorination or sulfoxidation with subsequent hydrolysis and neutralization. The esters of α-sulfo fatty acids (estersulfonates), for example, α-sulfonated methyl esters of hydrogenated coconut, palm kernel, or tallow fatty acids, are likewise suitable.

Further suitable anionic surfactants are sulfonated fatty acid glycerol esters. “Fatty acid glycerol esters” are to be understood as the mono-, di- and triesters, and mixtures thereof, that are obtained during the production by esterification of a monoglycerol with 1 to 3 mol fatty acid, or upon transesterification of triglycerides with 0.3 to 2 mol glycerol. Preferred sulfonated fatty acid glycerol esters are the sulfonation products of saturated fatty acids having 6 to 22 carbon atoms (e.g., hexanoic acid, octanoic acid, decanoic acid, myristic acid, lauric acid, palmitic acid, stearic acid, or behenic acid).

Preferred alk(en)yl sulfates are the alkali, and particularly sodium salts of the sulfuric acid semi-esters of the C₁₂-C₁₈ fatty alcohols (e.g., from coconut fatty alcohol, tallow fatty alcohol, lauryl, myristyl, cetyl, or stearyl alcohol), or of the C₁₀-C₂₀ oxo alcohols, and those semi-esters of secondary alcohols of those chain lengths. Also preferred are alk(en)yl sulfates of the aforesaid chain length that contain a synthetic straight-chain alkyl residue produced on a petrochemical basis, which possess a breakdown behavior analogous to those appropriate compounds based on fat-chemistry raw materials. For purposes of washing technology, the C₁₂-C₁₆ alkyl sulfates and C₁₂-C₁₅ alkyl sulfates, as well as C₁₄-C₁₅ alkyl sulfates, are preferred. Other suitable anionic surfactants are 2,3-alkyl sulfates commercially obtainable from the Shell Oil Company under the trade name DAN®.

Sulfuric acid monoesters of straight-chain or branched C₇₋₂₁ alcohols ethoxylated with 1 to 6 mol ethylene oxide, such as 2-methyl-branched C₉₋₁₁ alcohols having an average of 3.5 mol ethylene oxide (EO) or C₁₂₋₁₈ fatty alcohols having 1 to 4 EO, are also suitable. Because of their high-foaming behavior they are used in cleaning agents only in relatively small quantities, for example, in quantities from about 1 to about 5 wt %.

Additional suitable anionic surfactants are also the salts of alkylsulfosuccinic acid, which are also referred to as sulfosuccinates or as sulfosuccinic acid esters and represent the monoesters and/or diesters of sulfosuccinic acid with alcohols, by preference fatty alcohols and in particular ethoxylated fatty alcohols. Preferred sulfosuccinates contain C₈ to C₁₈ fatty alcohol residues or mixtures thereof. Particularly preferred sulfosuccinates contain a fatty alcohol residue that is derived from ethoxylated fatty alcohols that, considered per se, represent nonionic surfactants. Sulfosuccinates whose fatty alcohol residues derive from ethoxylated fatty alcohols having a restricted homolog distribution are, in turn, particularly preferred. It is likewise also possible to use alk(en)ylsuccinic acid having by preference 8 to 18 carbon atoms in the alk(en)yl chain, or salts thereof.

Betaines or alkylamidoalkylamines are, for example, suitable as amphoteric surfactants.

Suitable betaines include alkyl betaines, alkylamidobetaines, imidazolinium betaines, sulfobetaines (INCI sultaines), and phosphobetaines, and preferably conform to the formula (R^{A})(R^{B})(R^{C})N⁺CH₂COO⁻ wherein R^{A} is an alkyl residue, if applicable interrupted by heteroatoms or heteroatom groups, having 8 to 25, by preference 10 to 21 carbon atoms, and R^{B} and R^{C} are similar or different alkyl residues having 1 to 3 carbon atoms, in particular C₁₀ to C₁₈ alkyldimethylcarboxymethyl betaines and C₁₁ to C₁₇ alkylamidopropyldimethylcarboxymethyl betaines, or conform to the formula R¹—[CO—X—(CH₂)ₙ]ₓ—N⁺(R^{II})(R^{III})—(CH₂)ₘ—[CH(OH)—CH₂]_{y}—Y⁻ wherein—
R¹ is a saturated or unsaturated C₆₋₂₂ alkyl residue, preferably C₈₋₁₈ alkyl residue, in particular a saturated C₁₀₋₁₆ alkyl residue, for example a saturated C₁₂₋₁₄ alkyl residue,
X is NH, NR^{IV} having the C₁₋₄ alkyl residue R^{IV}, O, or S,
n is a number from 1 to 10, by preference 2 to 5, in particular 3,
x is 0 or 1, by preference 1,
R^{II}, R^{III} are independently a C₁₋₄ alkyl residue, optionally hydroxy-substituted, for example, a hydroxyethyl residue, in particular, a methyl residue,
m is a number from 1 to 4, in particular 1, 2, or 3,
y is 0 or 1, and
Y is COO, SO₃, OPO(OR^{V})O or P(O)OR^{V})O, R^{V} being a hydrogen atom H or a C₁₋₄ alkyl residue.

Alkyl betaines and alkylamidobetaines, betaines of the aforesaid formula having a carboxylate group (Y⁻═COO⁻), are also called carbobetaines.

Preferred amphoteric surfactants are alkyl betaines of formula A1, alkylamidobetaines of formula A2, sulfobetaines of formula A3, and amidosulfobetaines of formula A4:

R¹—N⁺—(CH₃)₂—CH₂COO⁻ (A1)

R¹—CO—NH—(CH₂)₃—N⁺(CH₃)₂—CH₂COO⁻ (A2)

R¹—N⁺(CH₃)₂—CH₂CH(OH)CH₂SO₃⁻ (A3)

R¹—CO—NH—(CH₂)₃—N⁺(CH₃)₂—CH₂CH(OH)CH₂SO₃⁻ (A4)

wherein R¹ has the same meaning as in formula A.

Particularly preferred amphoteric surfactants include the carbobetaines, in particular, the carbobetaines of formulas A1 and A2, more preferably the alkylamidobetaines of formula A2.

Examples of suitable betaines and sulfobetaines include the following compounds named in accordance with INCI: Almondamidopropyl Betaine, Apricotamidopropyl Betaine, Avocadamidopropyl Betaine, Babassuamidopropyl Betaine, Behenamidopropyl Betaine, Behenyl Betaine, Betaine, Canolamidopropyl Betaine, Capryl/Capramidopropyl Betaine, Carnitine, Cetyl Betaine, Cocamido-ethyl Betaine, Cocamidopropyl Betaine, Cocamidopropyl Hydroxysultaine, Coco-Betaine, Coco-Hydroxysultaine, Coco/Oleamidopropyl Betaine, Coco-Sultaine, Decyl Betaine, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl PG-Betaine, Erucamidopropyl Hydroxysultaine, Hydrogenated Tallow Betaine, Isostearamidopropyl Betaine, Lauramidopropyl Betaine, Lauryl Betaine, Lauryl Hydroxysultaine, Lauryl Sultaine, Milkamidopropyl Betaine, Minkamidopropyl Betaine, Myristamidopropyl Betaine, Myristyl Betaine, Oleamidopropyl Betaine, Oleamidopropyl Hydroxysultaine, Oleyl Betaine, Olivamidopropyl Betaine, Palmamidopropyl Betaine, Palmitamidopropyl Betaine, Palmitoyl Carnitine, Palm Kernelamidopropyl Betaine, Polytetrafluoroethylene Acetoxypropyl Betaine, Ricinoleamidopropyl Betaine, Sesamidopropyl Betaine, Soyamidopropyl Betaine, Stearamidopropyl Betaine, Stearyl Betaine, Tallowamidopropyl Betaine, Tallowamidopropyl Hydroxysultaine, Tallow Betaine, Tallow Dihydroxyethyl Betaine, Undecylenamidopropyl Betaine, and Wheat Germamidopropyl Betaine. A preferred amphoteric surfactant is Cocamidopropyl Betaine. A particularly preferred amphoteric surfactant is Capryl/Capramidopropyl Betaine (CAB), which is obtainable e.g. under the trade name Tegotens® B 810 from Th. Goldschmidt AG.

Alkylamido Alkylamines (per INCI) are amphoteric surfactants of the formula R^{VI}—CO—NR^{VII}—(CH₂)ᵢ—N(R^{VIII})—(CH₂CH₂O)ⱼ—(CH₂)ₖ—[CH(OH)]ₗ—CH₂—Z—OM wherein
R^{VI} is a saturated or unsaturated C₆₋₂₂ alkyl residue, preferably a C₈₋₁₈ alkyl residue, in particular a saturated C₁₀₋₁₆ alkyl residue, for example a saturated C₁₂₋₁₄ alkyl residue,
R^{VII} is a hydrogen atom H or a C₁₋₄ alkyl residue, preferably H,
i is a number from 1 to 10, preferably 2 to 5, in particular 2 or 3,
R^{VIII} is a hydrogen atom H or CH₂COOM (see below for M),
j is a number from 1 to 4, preferably 1 or 2, in particular 1,
k is a number from 0 to 4, preferably 0 or 1,
l is 0 or 1, such that k=1 when l=1,
Z is CO, SO₂, OPO(OR¹²), or P(O)(OR¹²), where R¹² is a C₁₋₄ alkyl residue or M (see below), and
M is hydrogen, an alkali metal, an alkaline-earth metal, or a protonated alkanolamine

(e.g., a protonated mono-, di-, or triethanolamine).

Preferred representatives conform to formulas B1 to B4:

R^{VI}—CO—NH—(CH₂)₂—N(R^{VIII})—CH₂CH₂O—CH₂—COOM (B1)

R^{VI}—CO—NH—(CH₂)₂—N(R^{VIII})—CH₂CH₂O—CH₂CH₂—COOM (B2)

R^{VI}—CO—NH—(CH₂)₂—N(R^{VIII})—CH₂CH₂O—CH₂CH(OH)CH₂—SO₃M (B3)

R^{VI}—CO—NH—(CH₂)₂—N(R^{VIII})—CH₂CH₂O—CH₂CH(OH)CH₂—OPO₃HM (B4)

in which R^{VI}, R^{VIII}, and M have the same meanings as in formula B.

Examples of alkylamidoalkylamines include the following compounds named according to INCI: Cocoamphodipropionic Acid, Cocobetainamido Amphopropionate, DEA-Cocoamphodipropionate, Disodium Caproamphodiacetate, Disodium Caproamphodipropionate, Disodium Capryloamphodiacetate, Disodium Capryloamphodipropionate, Disodium Cocoamphocarboxyethylhydroxypropylsulfonate, Disodium Cocoamphodiacetate, Disodium Cocoamphodipropionate, Di sodium Isostearoamphodiacetate, Disodium Isostearoamphodipropionate, Disodium Laureth-5 Carboxyamphodiacetate, Disodium Lauroamphodiacetate, Disodium Lauroamphodipropionate, Disodium Oleoamphodipropionate, Disodium PPG-2-lsodeceth-7 Carboxyamphodiacetate, Disodium Stearoamphodiacetate, Disodium Tallowamphodiacetate, Disodium Wheatgermamphodiacetate, Lauroamphodipropionic Acid, Quatemium-85, Sodium Caproamphoacetate, Sodium Caproamphohydroxypropylsulfonate, Sodium Caproamphopropionate, Sodium Capryloamphoacetate, Sodium Capryloamphohydroxypropylsulfonate, Sodium Capryloamphopropionate, Sodium Cocoamphoacetate, Sodium Coco amphohydroxypropyl sulfonate, Sodium Co coamphopropionate, Sodium Cornamphopropionate, Sodium Isostearoamphoacetate, Sodium Isostearoamphopropionate, Sodium Lauroamphoacetate, Sodium Lauroamphohydroxypropylsulfonate, Sodium Lauroampho PG-Acetate Phosphate, Sodium Lauroamphopropionate, Sodium Myristoamphoacetate, Sodium Oleoamphoacetate, Sodium Oleoamphohydroxypropylsulfonate, Sodium Oleoamphopropionate, Sodium Ricinoleoamphoacetate, Sodium Stearoamphoacetate, Sodium Stearoamphohydroxypropylsulfonate, Sodium Stearoamphopropionate, Sodium Tallamphopropionate, Sodium Tallowamphoacetate, Sodium Undecylenoamphoacetate, Sodium Undecylenoamphopropionate, Sodium Wheat Germamphoacetate, and Trisodium Lauroampho PG-Acetate Chloride Phosphate.

Appropriate foam inhibitors include soaps, oils, fats, paraffins, or silicone oils, which optionally can be applied onto carrier materials. Suitable carrier materials include inorganic salts such as carbonates or sulfates, cellulose derivatives, or silicates, as well as mixtures of the aforesaid materials. Agents preferred in the context of the present Application contain paraffins, preferably unbranched paraffins (n-paraffins), and/or silicones, preferably linear-polymer silicones constructed according to the (R₂SiO)ₓ pattern and are also referred to as silicone oils.

In order to increase cleaning performance, dishwashing agents according to the present invention can also contain enzymes. These include proteases, amylases, lipases, hemicellulases, cellulases, perhydrolases, or oxidoreductases, as well as preferably mixtures thereof. These enzymes are, in principle, of natural origin; improved variants based on the natural molecules are available for use in washing and cleaning agents and are correspondingly preferred for use. Washing or cleaning agents contain enzymes by preference in total quantities from 1×10⁻⁶ to 5 wt %, based on active protein. The protein concentration can be determined with known methods, for example the BCA process or the biuret process.

Among the proteases, those of the subtilisin type are preferred. Examples thereof are the subtilisins BPN′ and Carlsberg and their further-developed forms, protease PB92, subtilisins 147 and 309, the alkaline protease from Bacillus lentus, subtilisin DY, and the enzymes (to be classified, however, as subtilases and no longer as subtilisins in the narrower sense) thermitase, proteinase K, and proteases TW3 and TW7.

Examples of amylases usable according to the present invention are the α-amylases from Bacillus licheniformis, B. amyloliquefaciens, B. stearothermophilus, Aspergillus niger, and A. oryzae, and the further developments of the aforesaid amylases improved for use in washing and cleaning agents. Additionally to be highlighted for this purpose are the α-amylase from Bacillus sp. A 7-7 (DSM 12368) and the cyclodextrin-glucanotransferase (CGTase) from B. agaradherens (DSM 9948).

Additionally usable according to the present invention are lipases or cutinases, in particular because of their triglyceride-cleaving activities but also in order to generate peracids in situ from suitable precursors. These include, for example, the lipases obtainable originally from Humicola lanuginosa (Thermomyces lanuginosus) or further-developed lipases, in particular those having the D96L amino acid exchange. Also usable, for example, are the cutinases that were originally isolated from Fusarium solani pisi and Humicola insolens. Also usable are lipases and cutinases, respectively, whose starting enzymes were originally isolated from Pseudomonas mendocina and Fusarium solanii.

It is also possible to use enzymes that are grouped under the term “hemicellulases.” These include, for example, mannanases, xanthanlyases, pectinlyases (=pectinases), pectinesterases, pectatelyases, xyloglucanases (=xylanases), pullulanases, and ®-glucanases.

To enhance the bleaching effect, according to the present invention oxidoreductases, for example oxidases, oxygenases, catalases, peroxidases such as halo-, chloro-, bromo-, lignin, glucose, or manganese peroxidases, dioxygenases, or laccases (phenoloxidases, polyphenoloxidases) can be used. Advantageously, preferably organic, particularly preferably aromatic compounds that interact with the enzymes are additionally added in order to intensify the activity of the relevant oxidoreductases (enhancers) or, if there is a large difference in redox potentials between the oxidizing enzymes and the stains, to ensure electron flow (mediators).

A protein and/or enzyme can be protected, especially during storage, from damage such as inactivation, denaturing, or decomposition (e.g., resulting from physical influences, oxidation, or proteolytic cleavage). Inhibition of proteolysis is particularly preferred in the context of microbial recovery of the proteins and/or enzymes, in particular when the agents also contain proteases. Washing or cleaning agents can contain stabilizers for this purpose; the provision of such agents represents a preferred embodiment of the present invention.

Those automatic dishwashing agents in which the automatic dishwashing agent contains, based on total weight, about 0.1 to about 12 wt %, by preference about 0.2 to about 10 wt %, and in particular 0.5 to about 8 wt % enzyme preparations, are particularly preferred.

Proteases and amylases having washing or cleaning activity are made available as a rule not in the form of the pure protein but instead in the form of stabilized, storable and transportable preparations. Included among these prepackaged preparations are, for example, the solid preparations obtained by granulation, extrusion, or lyophilization or, especially in the case of liquid or gelled agents, solutions of the enzymes, advantageously as concentrated as possible, low in water, and/or with stabilizers or further adjuvants added.

Alternatively, the enzymes can be encapsulated for both the solid and the liquid administration form, for example by spray-drying or extruding the enzyme solution together with a preferably natural polymer, or in the form of capsules, for example those in which the enzymes are enclosed in a solidified gel, or in those of the core-shell type, in which an enzyme-containing core is covered with a protective layer impermeable to water, air, and/or chemicals. Further active substances, for example stabilizers, emulsifiers, pigments, bleaching agents, or dyes, can additionally be applied in superimposed layers. Such capsules are applied in accordance with methods known per se, for example by vibratory or rolling granulation or in fluidized bed processes. Such granulates are advantageously low in dust, e.g. as a result of the application of polymeric film-forming agents, and are stable in storage thanks to the coating.

It is furthermore possible to package two or more enzymes together so that a single granulate exhibits several enzyme activities.

As is apparent from the statements above, the enzyme protein constitutes only a fraction of the total weight of usual enzyme preparations. Protease and amylase preparations used in preferred fashion according to the present invention contain from about 0.1 to about 40 wt %, preferably about 0.2 to about 30 wt %, particularly preferably about 0.4 to about 20 wt %, and in particular about 0.8 to about 10 wt % of the enzyme protein.

Some examples of formulations for preferred automatic dishwashing agents according to the present invention are illustrated in the tables below:

| | Formulation 37 | Formulation 38 | Formulation 39 | Formulation 40 |
|---|---|---|---|---|
| Ingredient | (wt %) | (wt %) | (wt %) | (wt %) |
| Tripolyphosphate | 3 to 40 | 3 to 30 | 3 to 30 | 2 to 15 |
| Carbonate | 3 to 20 | 3 to 20 | 3 to 20 | 4 to 15 |
| Phosphonate | >1.5 | >1.5 | >1.5 | >1.5 |
| Anionic copolymer* | 0.1 to 20 | 0.2 to 18 | 0.5 to 15 | 1 to 12 |
| Nonionic surfactant | 0.1 to 15 | 0.2 to 10 | 0.5 to 8 | 1 to 6 |
| Protease preparation | 0.1 to 12 | 0.2 to 10 | 0.5 to 8 | 0.5 to 8 |
| Amylase preparation | 0.1 to 12 | 0.2 to 10 | 0.5 to 8 | 0.5 to 8 |
| Water | 10 to 80 | 20 to 70 | 30 to 70 | 30 to 70 |
| miscellaneous | to 100 | to 100 | to 100 | to 100 |
| | Formulation 41 | Formulation 42 | Formulation 43 | Formulation 44 |
| Ingredient | (wt %) | (wt %) | (wt %) | (wt %) |
| Sodium | 3 to 40 | 3 to 30 | 3 to 30 | 2 to 15 |
| tripolyphosphate | | | | |
| Sodium carbonate | 3 to 20 | 3 to 20 | 3 to 20 | 4 to 15 |
| Phosphonate | >1.5 | >1.5 | >1.5 | >1.5 |
| Anionic copolymer* | 0.1 to 20 | 0.2 to 18 | 0.5 to 15 | 1 to 12 |
| Nonionic surfactant | 0.1 to 15 | 0.2 to 10 | 0.5 to 8 | 1 to 6 |
| Protease preparation | 0.1 to 12 | 0.2 to 10 | 0.5 to 8 | 0.5 to 8 |
| Amylase preparation | 0.1 to 12 | 0.2 to 10 | 0.5 to 8 | 0.5 to 8 |
| Water | 10 to 80 | 20 to 70 | 30 to 70 | 30 to 70 |
| miscellaneous | to 100 | to 100 | to 100 | to 100 |

*Anionic copolymer comprising
i) unsaturated carboxylic acid(s),
ii) sulfonic acid group-containing monomer(s).

Cleaning performance of automatic dishwashing agents according to the present invention can be improved by the addition of organic solvents. A preferred subject of the present Application is therefore automatic dishwashing agents that, in addition to the other ingredients referred to, further contain at least one organic solvent. Preferred liquid automatic dishwashing agents comprise, based on total weight, organic solvent in quantities from about 0.2 to about 15 wt %, by preference about 0.5 to about 12 wt %, particularly preferably about 1.0 to about 10 wt %.

These organic solvents derive, for example, from monoalcohols, diols, triols or polyols, ethers, esters, and/or amides. Water-soluble organic solvents are particularly preferred in this context, “water-soluble” solvents for purposes of the present Application being solvents that are completely miscible with water (i.e., with no miscibility gap) at room temperature.

Organic solvents that can be used in agents according to the present invention derive from monovalent or polyvalent alcohols, alkanolamines, or glycol ethers, provided they are miscible with water in the indicated concentration range. The solvents are by preference chosen from ethanol, n-propanol or isopropanol, butanols, glycol, propanediol or butanediol, in particular 1,2-propanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, or propylene glycol propyl ether, dipropylene glycol methyl ether or dipropylene glycol ethyl ether, methoxytriglycol, ethoxytriglycol, or butoxytriglycol, 1-butoxyethoxy-2-propanol, 3-methyl-3-methoxybutanol, propylene glycol t-butyl ether, and mixtures of these solvents.

Organic solvents from organic amines and/or alkanolamines are particularly effective in terms of cleaning performance, and in this context in turn with regard to cleaning performance on bleachable stains, particularly on tea stains.

Preferred organic amines are, in particular, primary and secondary alkylamines, alkylenamines, and mixtures of said organic amines. Included in the group of the preferred primary alkylamines are monomethylamine, monoethylamine, monopropylamine, monobutylamine, monopentylamine, and cyclohexylamine. The group of the preferred secondary alkylamines includes, in particular, dimethylamine.

Preferred alkanolamines are, in particular, primary, secondary, and tertiary alkanolamines and mixtures thereof. Particularly preferred primary alkanolamines are monoethanolamine (2-aminoethanol, MEA), monoisopropanolamine, diethylethanolamine (2-(diethylamino)ethanol). Particularly preferred secondary alkanolamines are diethanolamine (2,2′-iminodiethanol, DEA, bis(2-hydroxyethyl)amine), N-methyldiethanolamine, N-ethyldiethanolamine, diisopropanolamine, and morpholine. Particularly preferred tertiary alkanolamines are triethanolamine and triisopropanolamine.

The weight proportion of alkanolamine in terms of the total weight of automatic dishwashing agents preferred according to the present invention is about 0.1 to about 10 wt %, by preference about 0.2 to about 8 wt %, preferably about 0.4 to about 6 wt %, and in particular about 1 to about 5 wt %.

Some examples of formulations for preferred automatic dishwashing agents according to the present invention are illustrated in the tables below:

| | Formulation 45 | Formulation 46 | Formulation 47 | Formulation 48 |
|---|---|---|---|---|
| Ingredient | (wt %) | (wt %) | (wt %) | (wt %) |
| Tripolyphosphate | 3 to 40 | 3 to 30 | 3 to 30 | 2 to 15 |
| Carbonate | 3 to 20 | 3 to 20 | 3 to 20 | 4 to 15 |
| Phosphonate | >1.5 | >1.5 | >1.5 | >1.5 |
| Anionic copolymer* | 0.1 to 20 | 0.2 to 18 | 0.5 to 15 | 1 to 12 |
| Nonionic surfactant | 0.1 to 15 | 0.2 to 10 | 0.5 to 8 | 1 to 6 |
| Protease preparation | 0.1 to 12 | 0.2 to 10 | 0.5 to 8 | 0.5 to 8 |
| Amylase preparation | 0.1 to 12 | 0.2 to 10 | 0.5 to 8 | 0.5 to 8 |
| Alkanolamine | 0.1 to 10 | 0.2 to 8 | 0.4 to 6 | 1 to 5 |
| Water | 10 to 80 | 20 to 70 | 30 to 70 | 30 to 70 |
| miscellaneous | to 100 | to 100 | to 100 | to 100 |
| | Formulation 49 | Formulation 50 | Formulation 51 | Formulation 52 |
| Ingredient | (wt %) | (wt %) | (wt %) | (wt %) |
| Sodium | 3 to 40 | 3 to 30 | 3 to 30 | 2 to 15 |
| tripolyphosphate | | | | |
| Sodium carbonate | 3 to 20 | 3 to 20 | 3 to 20 | 4 to 15 |
| Phosphonate | >1.5 | >1.5 | >1.5 | >1.5 |
| Anionic copolymer* | 0.1 to 20 | 0.2 to 18 | 0.5 to 15 | 1 to 12 |
| Nonionic surfactant | 0.1 to 15 | 0.2 to 10 | 0.5 to 8 | 1 to 6 |
| Protease preparation | 0.1 to 12 | 0.2 to 10 | 0.5 to 8 | 0.5 to 8 |
| Amylase preparation | 0.1 to 12 | 0.2 to 10 | 0.5 to 8 | 0.5 to 8 |
| Alkanolamine | 0.1 to 10 | 0.2 to 8 | 0.4 to 6 | 1 to 5 |
| Water | 10 to 80 | 20 to 70 | 30 to 70 | 30 to 70 |
| miscellaneous | to 100 | to 100 | to 100 | to 100 |

*Anionic copolymer comprising
i) unsaturated carboxylic acid(s),
ii) sulfonic acid group-containing monomer(s).

Glass corrosion inhibitors are further preferred ingredients of automatic dishwashing agents according to the present invention. Glass corrosion inhibitors prevent the occurrence of clouding, smearing, and scratches, but also iridescence, on the glass surface of automatically cleaned glassware. Preferred glass corrosion inhibitors derive from the group of the magnesium and zinc salts and the magnesium and zinc complexes.

The spectrum of zinc salts, by preference of organic acids, particularly preferably of organic carboxylic acids, that are preferred according to the present invention extends from salts that are poorly soluble or insoluble in water (i.e., exhibit a solubility below 100 mg/l, by preference below 10 mg/l, in particular below 0.01 mg/l) to those salts that exhibit a solubility in water above 100 mg/l, preferably above 500 mg/l, particularly preferably above 1 g/l, and in particular above 5 g/l (all solubilities at a water temperature of 20° C.). Zinc citrate, zinc oleate, and zinc stearate, for example, belong to the first group of zinc salts; zinc formate, zinc acetate, zinc lactate, and zinc gluconate, for example, belong to the group of the soluble zinc salts.

At least one zinc salt of an inorganic or organic carboxylic acid, particularly preferably a zinc salt from the group of zinc stearate, zinc oleate, zinc gluconate, zinc acetate, zinc lactate, and zinc citrate, is used with particular preference as a glass corrosion inhibitor. Zinc ricinoleate, zinc abietate, and zinc oxalate are also preferred.

In the context of the present invention, the zinc salt concentration in washing or cleaning agents is by preference about 0.1 to about 5 wt %, preferably about 0.2 to about 4 wt %, and in particular about 0.4 to about 3 wt %, or the concentration of zinc in oxidized form (calculated as Zn²⁺) is about 0.01 to about 1 wt %, by preference about 0.02 to about 0.5 wt %, and in particular about 0.04 to about 0.5 wt %, based in each case on the total weight of the glass corrosion inhibitor-containing agent.

In order to achieve the desired viscosity for the automatic dishwashing agent according to the present invention, thickening agents can be added to the agents.

A large group of particularly preferred thickening agents is synthetic polymers such as polyacrylic and polymethacrylic compounds, vinyl polymers, polycarboxylic acids, polyethers, polyimines, polyamides, and polyurethanes. Thickening agents from these substance classes, are widely commercially obtainable and are offered, for example, under the commercial names Acusol® 810, Acusol® 820 (methacrylic acid [stearyl alcohol 20 EO]ester/acrylic acid copolymer, 30% in water, Rohm & Haas), Dapral® GT-282-S (alkylpolyglycol ether, Akzo), Deuterol® Polymer 11 (dicarboxylic acid copolymer, Schoner GmbH), Deuteron® XG (anionic heteropolysaccharide based on β-D-glucose, D-mannose, D-glucuronic acid, Schoner GmbH), Deuteron® XN (nonionogenic polysaccharide, Schoner GmbH), Dicrylan® Thickener O (ethylene oxide adduct, 50% in water/isopropanol, Pfersse Chemie), EMA® 81 and EMA® 91 (ethylene-maleic acid. anhydride copolymer, Monsanto), QR-1001 thickener (polyurethane emulsion, 19 to 21% in water/diglycol ether, Rohm & Haas), Mirox® AM (anionic acrylic acid-acrylic acid ester copolymer dispersion, 25% in water, Stockhausen), SER AD FX 1100 (hydrophobic urethane polymer, Servo Delden), Shellflo® S (high-molecular-weight polysaccharide stabilized with formaldehyde, Shell), and Shellflo® XA (xanthan biopolymer stabilized with formaldehyde, Shell).

Examples of further thickening agents are agar-agar, carrageenan, tragacanth, gum arabic, alginates, pectins, polyoses, guar flour, locust bean flour, starch, dextrins, gelatins, casein, carboxymethyl cellulose, seed flour ethers, polyacrylic and polymethacrylic compounds, vinyl polymers, polycarboxylic acids, polyethers, polyimines, polyamides, polysilicic acids, clay minerals such as montmorillonites, zeolites, and silicic acids.

It has proven to be particularly advantageous if the automatic dishwashing agents according to the present invention contain the thickening agent in quantities from about 0.1 to about 8 wt %, preferably from about 0.2 to about 6 wt %, and particularly preferably from about 0.4 to about 4 wt %, based on total weight of the automatic dishwashing agent.

Pourability and settling stability of liquid automatic dishwashing agents according to the present invention can be influenced not only by the thickeners but also by the ratio of the potassium and sodium ions in said agents. Automatic dishwashing agents preferred according to the present invention that have a ratio of potassium to sodium ions above 1:1, by preference above 2:1, particularly preferably above 4:1, and in particular above 8:1, have proven advantageous.

Preparation and packaging of agents according to the present invention is accomplished using water-soluble or water-insoluble packaging means known to one skilled in the art. The packaging means can be single-, dual-, or multi-chamber containers.

Water-insoluble dual- or multi-chamber containers are particularly preferred. Dual- or multi-chamber containers of this kind typically have a total volume from about 100 to about 5000 ml, by preference from about 200 and 2000 ml. The volume of the individual chambers is by preference from about 50 to about 2000 ml, preferably from about 100 to about 1000 ml. Preferred dual- or multi-chamber containers are bottle-shaped. The automatic dishwashing agents according to the present invention are present in these packaging means by preference in the form of sub-formulations separated from one another. These sub-formulations do not form shared phase boundaries, but instead are located in regions of the packaging means that are separated from one another, and have compositions that differ from one another.

For dispensing of the liquid automatic dishwashing agents, the dual- or multi-chamber container by preference possesses at least one pouring spout, which can be configured e.g. in the form of one shared pouring spout for all the agents contained in the bottle. Those dual- or multi-chamber containers in which each of the receiving chambers of the container possesses its own pouring spout are, however, preferred. Such a configuration avoids, for example, contamination of individual chambers by ingredients from another chamber.

A further preferred subject of the present Application is therefore a liquid, low-alkalinity, and bleaching agent-free automatic dishwashing agent having a pH (20° C.) from about 8 to about 12 containing—

a) about 10 to about 60 wt % of one or more builders,

b) about 1.5 wt % or more phosphonate,

c) about 0.01 to about 20 wt % of an anionic copolymer comprising
i) unsaturated carboxylic acid(s),
ii) sulfonic acid group-containing monomer(s),
   wherein the automatic dishwashing agent is present in a dual- or multi-chamber container whose individual chambers are filled with sub-formulations of the automatic dishwashing agent.

Weight indications set forth above for the ingredients having washing and cleaning activity, and the information as to pH, of course refer to the automatic dishwashing agent obtained by combining all the sub-formulations. In the packaging by means of a dual- or multi-chamber container as described above, individual sub-formulations contained in the chambers can therefore deviate from the features characterizing automatic dishwashing agents according to the present invention, provided only that the combination of all sub-formulations yields an automatic dishwashing agent according to the present invention having the characterizing (and, if applicable, preferred) features recited above.

For example, individual sub-formulations can be free of phosphonate or of anionic copolymer, provided the combination of all sub-formulations yields an automatic dishwashing agent that contains about 1.5 wt % or more phosphonate and about 0.1 to about 20 wt % anionic copolymer encompassing i) unsaturated carboxylic acid(s) and ii) sulfonic acid group-containing monomer(s).

The information set forth herein before regarding pH of the low-alkalinity dishwashing agents according to the present invention also refers to the pH of the overall composition and not to the pH of any sub-formulations. Individual sub-formulations may therefore exhibit pH values (20° C.) below 8 or above 12, provided the combination of the sub-formulations yields an automatic dishwashing agent that has a pH (20° C.) from about 8 to about 12.

In the context of the packaging of automatic dishwashing agents according to the present invention into dual- or multi-chamber containers, it has proven advantageous, for the stability of any enzymes contained in said agents, to package those enzymes together with a nonionic surfactant in one of the chambers of the container. It has been possible to improve the cleaning performance of said agents by combined packaging of the enzyme and surfactant.

Some examples of formulations for automatic dishwashing agents preferred in this fashion are illustrated in the tables below:

| | Sub-formulation | Sub-formulation | Sub-formulation | Sub-formulation |
|---|---|---|---|---|
| Ingredient | 1 (wt %) | 2 (wt %) | 1 (wt %) | 2 (wt %) |
| | Automatic dishwashing agent 1 | | Automatic dishwashing agent 2 | |
| Tripolyphosphate | 3 to 40 | 3 to 30 | 3 to 30 | 2 to 15 |
| Carbonate | 0 to 10 | 3 to 20 | — | 4 to 15 |
| Phosphonate | 0 to 4 | 2 to 6 | 0 to 4 | 2 to 6 |
| Anionic copolymer* | 0 to 10 | 0.2 to 18 | — | 1 to 12 |
| Nonionic surfactant | 0.1 to 15 | 0 to 4 | 0.5 to 8 | — |
| Enzyme preparation | 0.1 to 12 | — | 0.5 to 8 | — |
| Water | 10 to 80 | 20 to 70 | 30 to 70 | 30 to 70 |
| Miscellaneous | to 100 | to 100 | to 100 | to 100 |
| | Automatic dishwashing agent 3 | | Automatic dishwashing agent 4 | |
| Potassium | 3 to 40 | 3 to 30 | 3 to 30 | 2 to 15 |
| tripolyphosphate | | | | |
| Sodium carbonate | 0 to 10 | 3 to 20 | — | 4 to 15 |
| Phosphonate | 0 to 4 | 2 to 6 | 0 to 4 | 2 to 6 |
| Anionic copolymer* | 0 to 10 | 0.2 to 18 | — | 1 to 12 |
| Nonionic surfactant | 0.1 to 15 | 0 to 4 | 0.5 to 8 | — |
| Enzyme preparation | 0.1 to 12 | — | 0.5 to 8 | — |
| Water | 10 to 80 | 20 to 70 | 30 to 70 | 30 to 70 |
| miscellaneous | to 100 | to 100 | to 100 | to 100 |
| | Automatic dishwashing agent 5 | | Automatic dishwashing agent 6 | |
| Tripolyphosphate | 3 to 40 | 3 to 30 | 3 to 30 | 2 to 15 |
| Carbonate | 0 to 10 | 3 to 20 | — | 4 to 15 |
| HEDP | 0 to 4 | 2 to 6 | 0 to 4 | 2 to 6 |
| Anionic copolymer* | 0 to 10 | 0.2 to 18 | — | 1 to 12 |
| Nonionic surfactant | 0.1 to 15 | 0 to 4 | 0.5 to 8 | — |
| Protease preparation | 0.1 to 12 | — | 0.5 to 8 | — |
| Amylase preparation | 0.1 to 12 | — | 0.5 to 8 | — |
| Alkanolamine | — | 0.2 to 8 | — | 1 to 5 |
| Water | 10 to 80 | 20 to 70 | 30 to 70 | 30 to 70 |
| miscellaneous | to 100 | to 100 | to 100 | to 100 |
| | Automatic dishwashing agent 7 | | Automatic dishwashing agent 8 | |
| Potassium | 3 to 40 | 3 to 30 | 3 to 30 | 2 to 15 |
| tripolyphosphate | | | | |
| Sodium carbonate | 0 to 10 | 3 to 20 | — | 4 to 15 |
| HEDP | 0 to 4 | 2 to 6 | 0 to 4 | 2 to 6 |
| Anionic copolymer* | 0 to 10 | 0.2 to 18 | — | 1 to 12 |
| Nonionic surfactant | 0.1 to 15 | 0 to 4 | 0.5 to 8 | — |
| Protease preparation | 0.1 to 12 | — | 0.5 to 8 | — |
| Amylase preparation | 0.1 to 12 | — | 0.5 to 8 | — |
| Alkanolamine | — | 0.2 to 8 | — | 1 to 5 |
| Water | 10 to 80 | 20 to 70 | 30 to 70 | 30 to 70 |
| miscellaneous | to 100 | to 100 | to 100 | to 100 |

*Anionic copolymer comprising
i) unsaturated carboxylic acid(s),
ii) sulfonic acid group-containing monomer(s).

A further subject of the present Application is a process for cleaning tableware in an automatic dishwasher, utilizing liquid, low-alkalinity, and bleaching agent-free automatic dishwashing agents according to the present invention, the automatic dishwashing agents being dispensed into the interior of an automatic dishwasher by preference during execution of a dishwashing program, before the beginning of the main washing cycle, or in the course of the main washing cycle. Dispensing or introduction of the agent according to the present invention into the interior of the automatic dishwasher can be accomplished manually, but by preference the agent is dispensed into the interior of the automatic dishwasher by means of the dispensing chamber of the automatic dishwasher. By preference, no additional water softener and no additional rinsing agent are dispensed into the interior of the automatic dishwasher in the course of the cleaning process. A kit for an automatic dishwasher, comprising—
a) an automatic dishwashing agent according to the present invention, and
b) an instruction notifying the consumer that the automatic dishwashing agent is to be used without the addition of a rinsing agent and/or a water-softener salt,
   is a further subject of this Application.

The automatic dishwashing agents according to the present invention exhibit their advantageous cleaning properties, in particular, in low-temperature cleaning processes. Preferred dishwashing process using agents according to the present invention are therefore characterized in that said method are carried out at temperatures up to a maximum of about 55° C., by preference up to a maximum of about 50° C.

As described earlier, agents according to the present invention are notable for improved cleaning performance on bleachable stains as compared with conventional automatic dishwashing agents. A further subject of the present Application is therefore the use of an automatic dishwashing agent according to the present invention to improve the cleaning of bleachable stains in the context of automatic dishwashing.

### EXAMPLES

In an automatic dishwashing process, stained tableware was washed in an automatic dishwasher (Miele G 698) at a water hardness of 21° dH and a temperature of 50° C. using 33 ml of the automatic dishwashing agents listed in the table below.

| Ingredient | V1 (wt %) | V2 (wt %) | E1 (wt %) | E2 (wt %) |
|---|---|---|---|---|
| Sodium tripolyphosphate | 14 | 14 | 14 | 14 |
| Sodium carbonate | 4.0 | 4.0 | 4.0 | 4.0 |
| HEDP | 1.0 | 1.5 | 1.8 | 3.0 |
| Anionic copolymer* | 4.0 | 4.0 | 4.0 | 4.0 |
| Nonionic surfactant | 2.0 | 2.0 | 2.0 | 2.0 |
| Protease preparation | 2.0 | 2.0 | 2.0 | 2.0 |
| Amylase preparation | 0.8 | 0.8 | 0.8 | 0.8 |
| Alkanolamine | 1.5 | 1.5 | 1.5 | 1.5 |
| Water | 55 | 55 | 55 | 55 |
| miscellaneous | to 100 | to 100 | to 100 | to 100 |

*Anionic copolymer comprising
i) unsaturated carboxylic acid(s),
ii) sulfonic acid group-containing monomer(s).

Tea cleaning of the automatic dishwashing agents was assessed using the IKW method. The results are indicated in the table below (the values indicated were obtained as averages of three experiments):

| | V1 | V2 | E1 | E2 |
|---|---|---|---|---|
| Tea cleaning | 1.0 | 1.5 | 2.5 | 3.0 |

We claim:

1. Liquid, low-alkalinity, and bleaching agent-free automatic dishwashing agent having a pH (20° C.) from about 8 to about 12, comprising:
a) about 10 to about 60 wt % of one or more builders,
b) at least 1.5 wt % of one or more phosphonates,
c) about 0.1 to about 20 wt % of an anionic copolymer comprising
i) unsaturated carboxylic acid(s), and
ii) sulfonic acid group-containing monomer(s).

2. Liquid automatic dishwashing agent according to claim 1, wherein the automatic dishwashing agent has a pH (20° C.) from about 9 to about 11.5.

3. Liquid automatic dishwashing agent according to claim 1, wherein the builders comprise at least two builders from the group of phosphates, carbonates, and citrates, wherein the weight proportion of these builders is from about 2 to about 50 wt %, based on total weight of the automatic dishwashing agent.

4. Liquid automatic dishwashing agent according to claim 1, wherein the automatic dishwashing agent comprises 1.8 wt % or greater phosphonate based on total weight of the agent.

5. Liquid automatic dishwashing agent according to claim 1 comprising at least 1-hydroxyethane-1,1-diphosphonic acid (HEDP) as the one or more phosphonates.

6. Liquid automatic dishwashing agent according to claim 1, wherein the one or more anionic copolymers is present in an amount of 0.2 to 18 wt % based on total weight of the dishwashing agent.

7. Liquid automatic dishwashing agent according to claim 1, wherein the anionic polymer is a copolymer comprising
i) unsaturated carboxylic acid(s),
ii) sulfonic acid group-containing monomer(s), and
iii) nonionogenic monomer(s).

8. Liquid automatic dishwashing agent according to claim 1, wherein the weight ratio of the constituents one or more anionic copolymers and one or more phosphonates is less than 2:1.

9. Liquid automatic dishwashing agent according to claim 1 further comprising one or more nonionic surfactants in an amount of from about 0.1 to about 15 wt %, based on total weight of the dishwashing agent.

10. Liquid automatic dishwashing agent according to claim 1 further comprising one or more enzymes in an amount of from about 0.1 to about 12 wt %, based on total weight of the dishwashing agent.

11. Process for cleaning tableware in an automatic dishwasher, washing the tableware with an automatic dishwashing agent according to claim 1.

12. Process according to claim 11, wherein no additional water softener and no additional rinsing agent are dispensed into the interior of the automatic dishwasher during the cleaning process.

13. Process according to claim 11, wherein the process is carried out at temperatures up to a maximum of 55° C.
